(19) United States
(12) Patent Application Publication
(10) Pub. No.: US 2015/0298002 A1
(43) Pub. Date: Oct. 22, 2015

(54) INFORMATION PROCESSING DEVICE AND GAME PROGRAM

(71) Applicant: DeNA Co., Ltd., Tokyo (JP)

(72) Inventors: Keisuke YOKOTA, Tokyo (JP); Akihiro SUGA, Tokyo (JP); Kentaro TAKAHASHI, Tokyo (JP)

(21) Appl. No.: 14/685,999

(22) Filed: Apr. 14, 2015

(30) Foreign Application Priority Data
Apr. 22, 2014 (JP) 2014-088136

(51) Int. Cl. A63F 13/46; A63F 13/537

(52) U.S. Cl. CPC A63F 13/46; A63F 13/537

(57) ABSTRACT

The information processing device that relates to the present invention places, in the game content placement area, at least one set of score-varying content which varies a player's score and special score-varying content which varies the score more strongly than the score-varying content; provides the player with game content selected in the game content placement area in response to the player's operations; and, when the game content provided to the player is the score-varying content or the special score-varying content, updates the player's score by varying it depending on the respective content.

This application claims the benefit of foreign priority under 35 USC 119(a) based on Japanese Patent Application No. 2014-088136, filed Apr. 22, 2014, the contents of which is incorporated herein by reference in its entirety.

### BACKGROUND

1. Technical Field

The present invention relates to an information processing device and a game program.

2. Background Art

Information processing devices are known that place a plurality of game content items, including special game content, in a game content placement area and provide a player with game content selected in the game content placement area in response to the player's operations (for example, see Patent Document 1).

### PRIOR ART LITERATURE

### Patent Literature

### Patent Document 1

Japanese Patent Application Publication No. 2014-57625.

### SUMMARY

In such information processing devices, characters of high rarity are provided to the player as special game content. However, the player cannot easily acquire characters of high rarity despite many attempts to do so and is provided with unnecessary characters (characters of low rarity), which creates a risk of reducing the player's motivation to play. On the other hand, should the player acquire a character of high rarity, the player's satisfaction tends to decrease the player's motivation to continue playing after acquisition.

The present invention has been devised by taking such circumstances into consideration, and it is an object of the invention to increase the player's motivation to play before and after acquiring special game content.

The main aspect of the present invention intended for solving the above-mentioned problems is an information processing device equipped with a screen data generation unit that generates screen data that is used to display, on a game screen, a game content placement area where a plurality of game content items are placed; a game content placement unit that places, in the game content placement area, at least one set of score-varying content that varies a player's score and special score-varying content that varies the score more strongly than the score-varying content; a game content provision unit that provides the player with game content selected in the game content placement area in response to the player's operations; and a score updating unit that updates the player's score by varying it in accordance with the respective content when the game content provided to the player is the score-varying content or the special score-varying content.

Other features of the present invention will become apparent from this Description and the accompanying drawings.

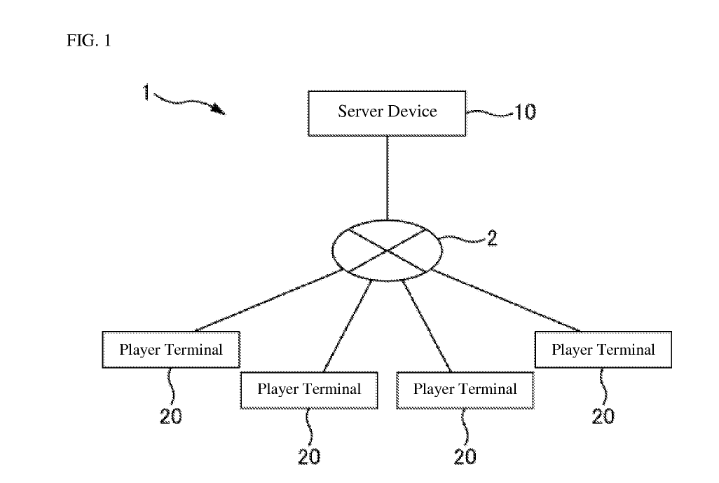

### BRIEF DESCRIPTION OF THE DRAWINGS

[FIG. 1]

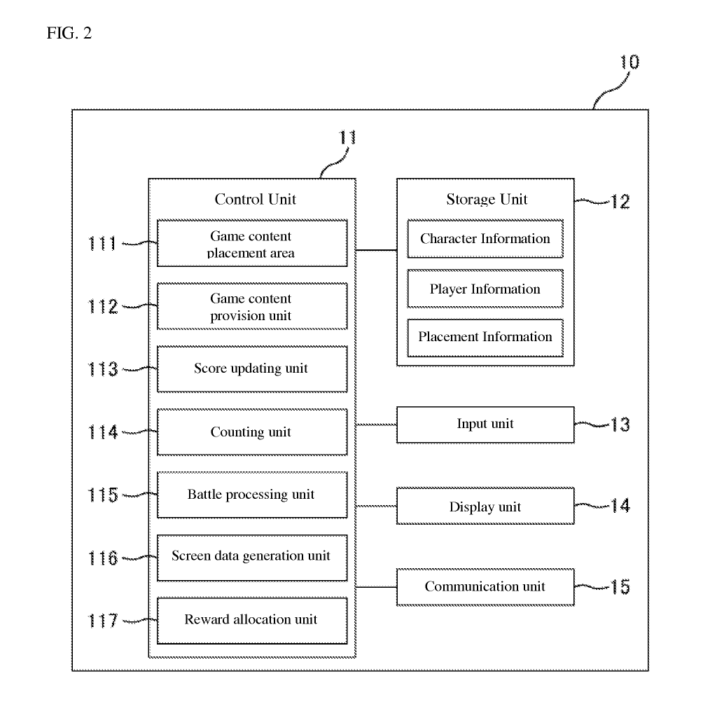

A diagram illustrating an example of the overall constitution of the game system 1.

[FIG. 2]

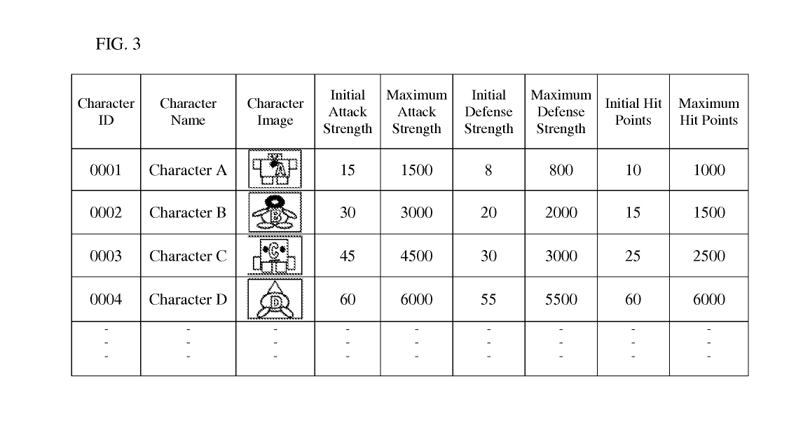

A block diagram illustrating the functional constitution of the server device 10.

[FIG. 3]

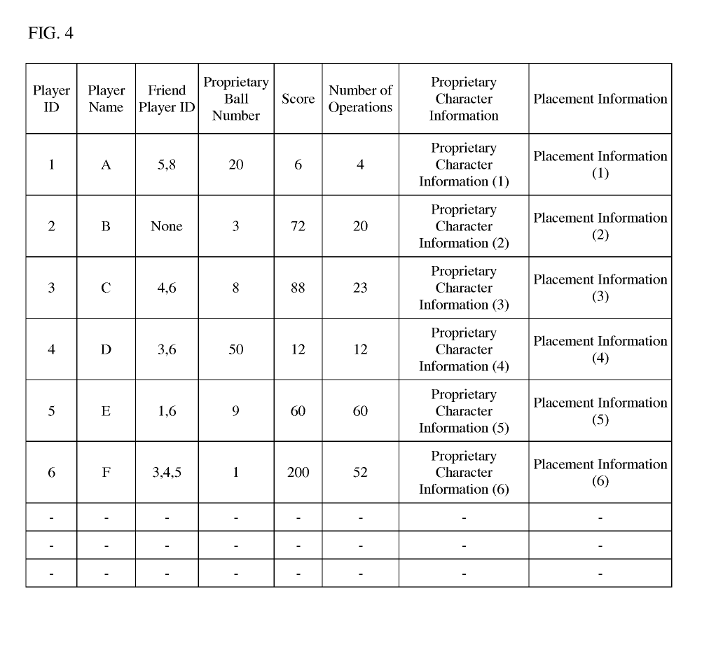

A diagram illustrating an example of a data structure of character information.

[FIG. 4]

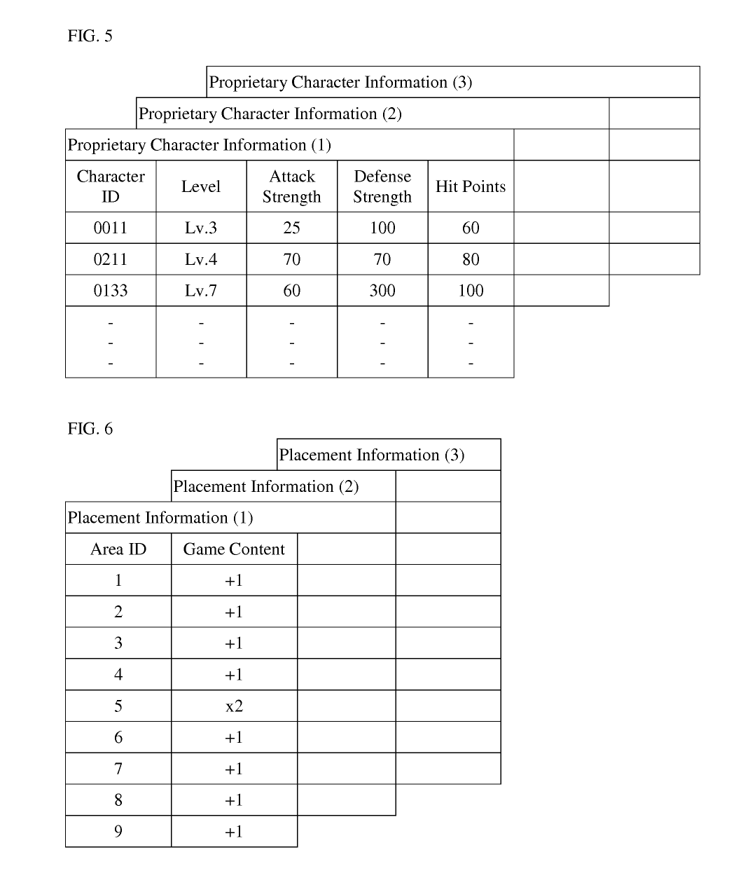

A diagram illustrating an example of a data structure of player information.

[FIG. 5]

A diagram illustrating an example of a data structure of proprietary character information.

[FIG. 6]

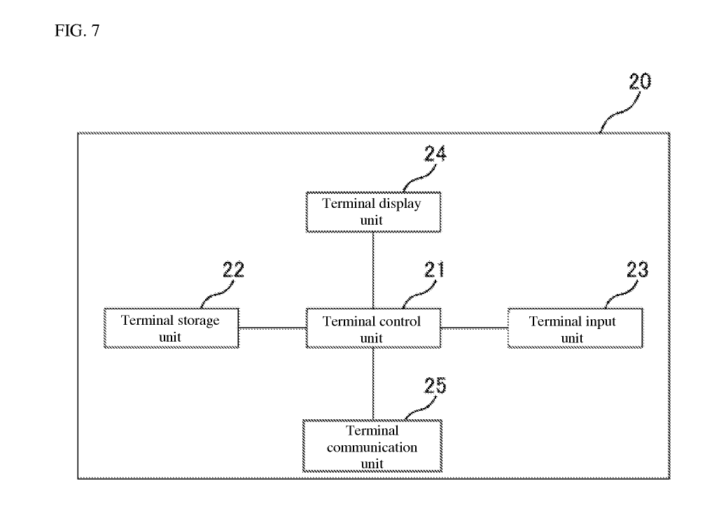

A diagram illustrating an example of a data structure of placement information.

[FIG. 7]

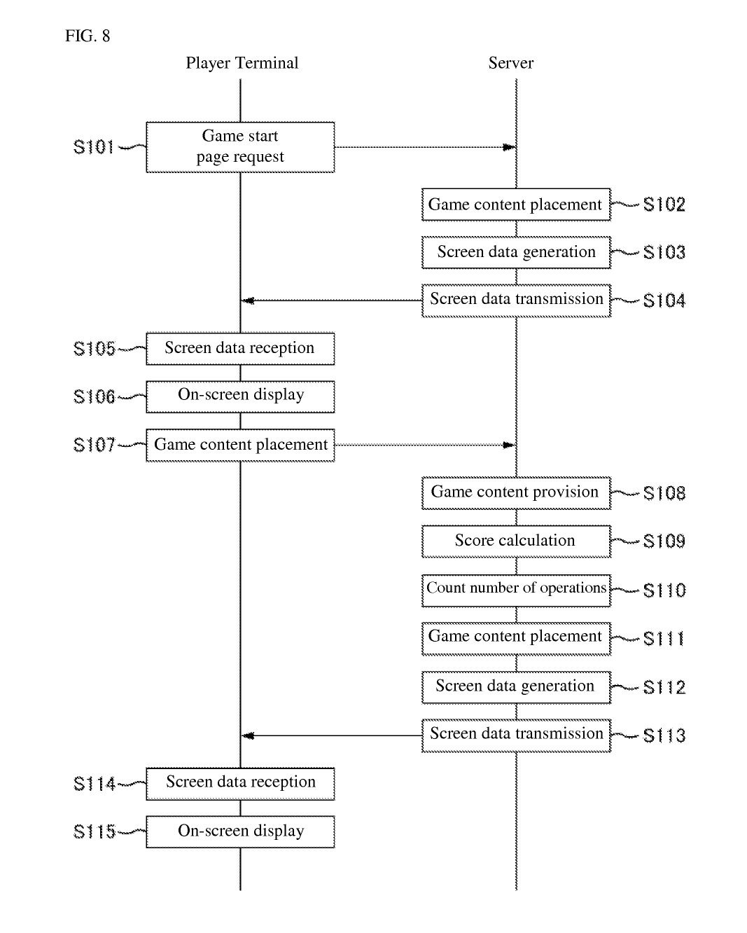

A block diagram illustrating the functional constitution of the player terminal 20.

[FIG. 8]

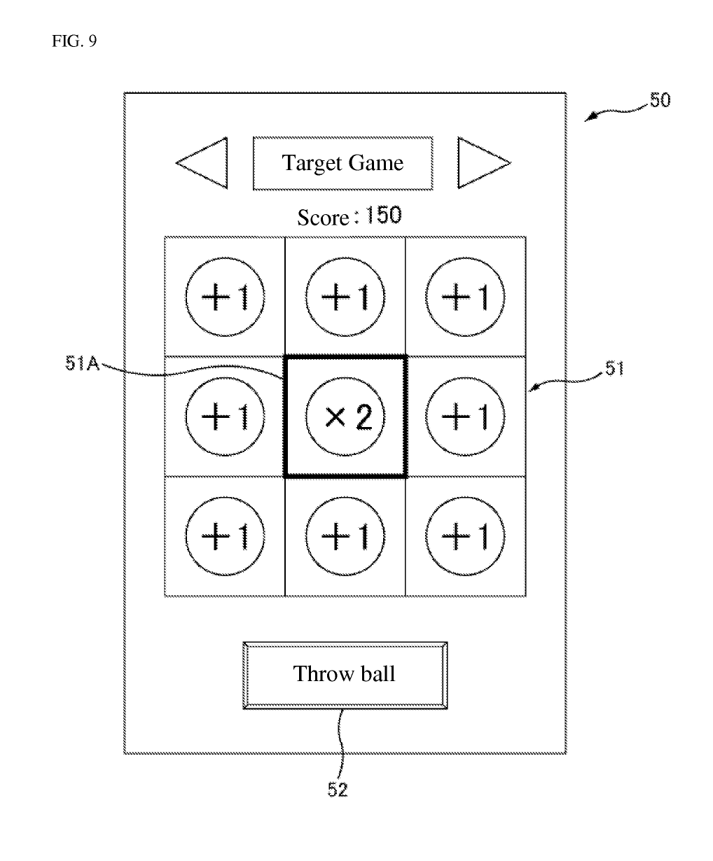

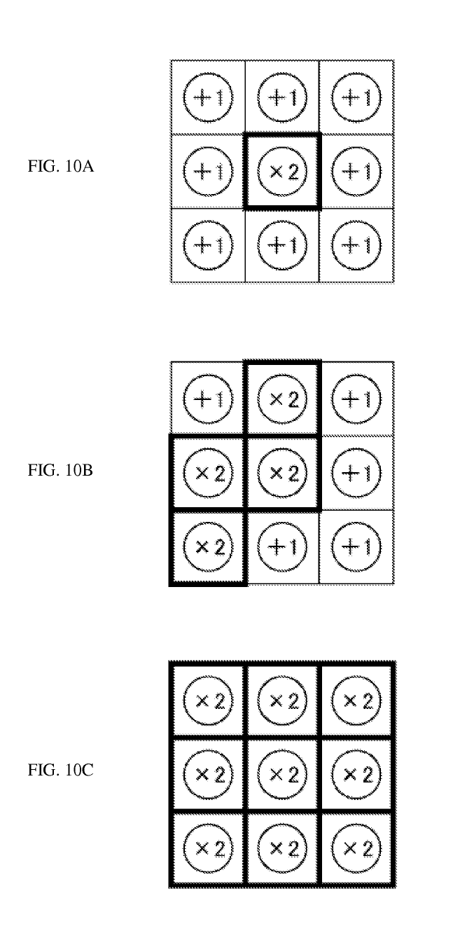

A flow chart illustrating an example of operation of the game system 1.

[FIG. 9]

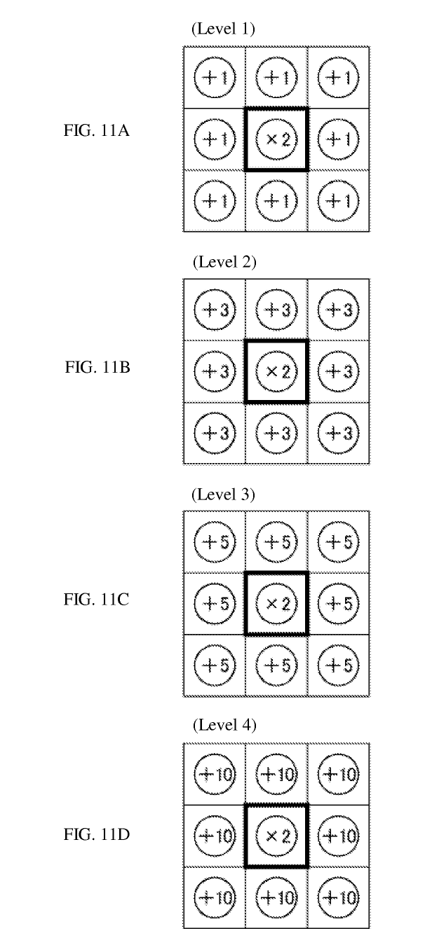

A diagram illustrating an example of a game screen 50 used in the target game.

[FIGS. 10A-10C]

A diagram illustrating state transitions in the game content placement area.

[FIGS. 11A-11D]

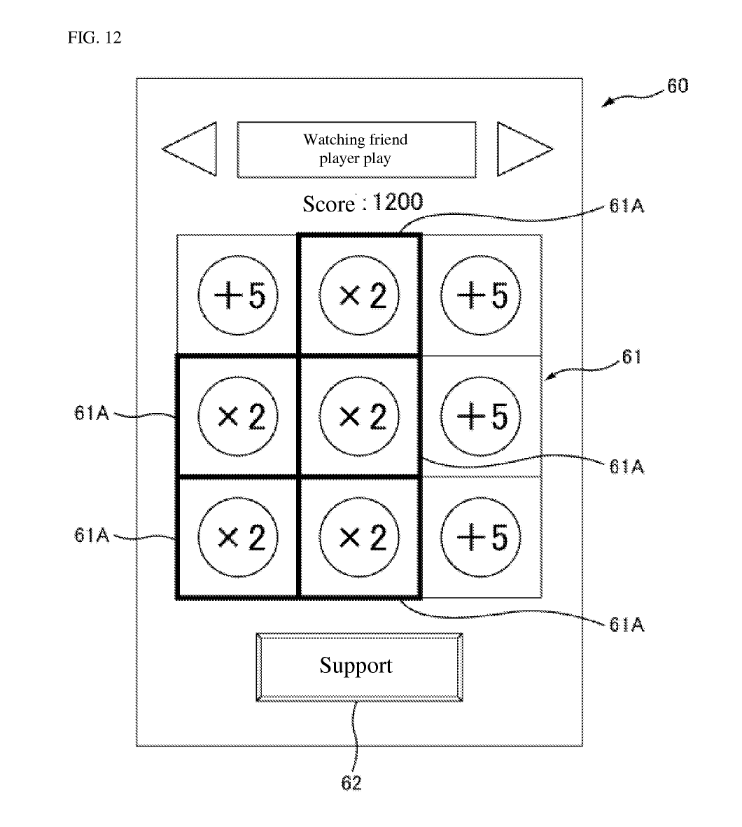

A diagram illustrating state transitions in the game content placement area.

[FIG. 12]

A diagram illustrating an example of a game screen 60 used for game viewing.

### DETAILED DESCRIPTION

At least the following will become apparent from this Description and the accompanying drawings.

Namely, an information processing device equipped with a screen data generation unit that generates screen data that is used to display, on a game screen, a game content placement area where a plurality of game content items are placed; a game content placement unit that places, in the game content placement area, at least one set of score-varying content that varies a player's score and special score-varying content that varies the score more strongly than the score-varying content; a game content provision unit that provides the player with game content selected in the game content placement area in response to the player's operations; and a score updating unit that updates the player's score by varying it in accordance with the respective content when the game content provided to the player is the score-varying content or the special score-varying content.

In such an information processing device, the provision of content is reflected in the player's score not only when special score-varying content is provided, but also when non-special score-varying content is provided, which allows for the player's motivation to play to be increased before and after acquiring the special game content.

In addition, the game content placement unit may be adapted to place more special score-varying content items in the game content placement area as the number of the player's operations increases.

In such an information processing device, the probability of providing special score-varying content can be increased by repeatedly playing the game, thereby making it possible to increase the motivation to play.

In addition, the game content provision unit may be adapted to increase the probability of selecting the above-mentioned special score-varying content items as the number of the player's operations increases.

In such an information processing device, the probability of providing special score-varying content can be increased by repeatedly playing the game, thereby making it possible to increase the motivation to play.

In addition, the device may be equipped with a counting unit that counts the number of the player's operations, and said counting unit resets the number of the player's operations upon lapse of a limited time during which game content can be provided, or upon provision of special score-varying content by the game content provision unit.

In such an information processing device, the number of operations counted up to the present moment is reset at predetermined moments in time, thereby making it possible to minimize excessive score variation.

In addition, the score updating unit may be adapted such that when the game content provided to the player is score-varying content, updating is performed by adding predetermined points to the player's score; when the game content provided to the player is special score-varying content, updating is performed by multiplying the player's score by a predetermined number larger than 1; and, furthermore, such that whenever the special score-varying content is provided by the game content provision unit, the predetermined points added to the player's score are increased relative to an initial value.

Such an information processing device makes it easier to increase the player's score because the added predetermined points are successively increased when special score-varying content items are provided. In addition, it becomes possible to substantially increase the player's score if special score-varying content is provided after increasing the score in this manner.

In addition, the score updating unit may be adapted to reset the predetermined points added to the player's score back to the initial value upon lapse of a limited time.

In such an information processing device, the player's score can be minimized to prevent it from increasing in an excessive manner.

In addition, a game program (e.g., non-transitory computer readable medium having machine-executable instructions) that directs a computer to execute a screen data generation process for generating screen data that is used to display, on a game screen, a game content placement area where a plurality of game content items are placed; a game content placement process for placing, in the game content placement area, at least one set of score-varying content that varies a player's score and special score-varying content that varies the score more strongly than the score-varying content; a game content provision process for providing the player with game content selected in the game content placement area in response to the player's operations; a score updating process for updating the player's score by varying the score in accordance with the respective content when the game content provided to the player is the score-varying content or the special score-varying content.

Such a game program makes it possible to increase the player's motivation to play before and after acquiring the special game content.

### Embodiments

### <<Constitution of Game System 1>>

FIG. 1 is a diagram illustrating an example of the overall constitution of the game system 1. The game system 1 provides various game-related services to players over a network 2 (for example, the Internet) and includes a server device 10 and a plurality of player terminals 20. The game system 1 according to the present embodiment can provide the players with a lottery game in which game content is determined by means of a lottery. A target game, as an example of such a lottery game, will be discussed below.

The target game of the present embodiment is a game in which game content awarded to the player is determined by means of a lottery and the player's score is varied based on the results of the lottery. In this target game, the game content placed in the game content placement area serves as the target. The game content placement area is split into 3×3, i.e. a total of 9 squares (unit areas), and game content is placed in each square. The game content that serves as the target includes score-varying content items and special score-varying content items. Lottery drawings are conducted by allowing the player to throw a ball, and the game content located in any of the 9 squares is awarded to the player. When lottery drawings are performed in this manner, the results of the lottery are reflected in the player's score. By repeatedly playing this target game, the players can increase their scores. In addition, the players can also obtain rewards corresponding to their scores. These rewards include character cards, which are an example of game content (hereinafter referred to simply as “characters”).

In addition, the game system 1 according to the present embodiment can provide the players with a battle game conducted using characters. The battle game of the present embodiment is a game in which characters owned by the players are engaged in battle with enemy characters acting as their opponents. The players can acquire balls used in the target game in accordance with the results of the battle.

### <<Constitution of Server Device 10>>

FIG. 2 is a block diagram illustrating the functional constitution of the server device 10. The server device 10 is an information processing device (for example, a workstation, a personal computer, or the like) used when a system administrator, etc., operates and manages various types of services. Upon receiving various commands (requests) from the player terminals 20, the server device 10 transmits (responds by sending) game programs operational on the player terminals 20 and various types of data, as well as web pages (game screens, etc.) created using a markup language (HTML, etc.) compliant with the specifications of the player terminals 20. The server device 10 has a control unit 11, a storage unit 12, an input unit 13, a display unit 14, and a communication unit 15.

Along with forwarding data between the components, the control unit 11 exercises overall control over the server device 10 and is implemented using a CPU (Central Processing Unit) that runs a predetermined program stored in memory. The control unit 11 of the present embodiment is equipped with at least a game content placement unit 111, a game content provision unit 112, a score updating unit 113, a counting unit 114, a battle processing unit 115, a screen data generation unit 116, and a reward allocation unit 117.

The game content placement unit 111 possesses functionality to execute a process whereby a plurality of game content items is placed in the game content placement area. The game content placement unit 111 of the present embodiment places score-varying content that varies the player's score and special score-varying content that varies the score more strongly than the score-varying content.

The game content provision unit 112 possesses the functionality to execute processing that is used to provide game content to the player. The game content provision unit 112 of the present embodiment provides the player with game content selected in the game content placement area in response to the player's operations.

The score updating unit 113 possesses the functionality to carry out processing that is required to update the player's score. The score updating unit 113 of the present embodiment updates the player's score by varying the score in accordance with the game content provided by the game content provision unit 112.

The counting unit 114 possesses the functionality to carry out processing that is required to count the number of the player's operations. The counting unit 114 of the present embodiment counts the number of operations and records it in the storage unit 12 whenever the player performs the operation of throwing a ball in the target game. In addition, the counting unit 114 resets the number of operations counted up to the present moment (accrued number of operations) at predetermined moments in time.

The battle processing unit 115 possesses functionality to carry out various types of battle game-related processing. The battle processing unit 115 of the present embodiment determines the winner in a battle with an enemy character. In addition, when the player character's victory is determined, it provides the player with balls used in the target game.

The screen data generation unit 116 possesses functionality to carry out processing used to generate screen data for displaying a game screen on a player terminal 20. The screen data generation unit 116 of the present embodiment generates HTML data as screen data corresponding to the game screen.

The reward allocation unit 117 possesses functionality to execute processing to allocate rewards to the player. The reward allocation unit 117 of the present embodiment allocates a reward corresponding to the score gained by the player in the target game.

The storage unit 12, which has a ROM (Read Only Memory), i.e. a read-only storage area where operating system software is stored, and a RAM (Random Access Memory), i.e. a rewritable storage area used as a work area for arithmetic processing by the control unit 11, is implemented using a flash memory, a hard disk, or another non-volatile storage device. The storage unit 12 of the present embodiment stores character information, player information, placement information, and various other types of data.

The input unit 13, which is used by a system administrator, etc., to enter various types of data (e.g., character information, etc.), is implemented, for example, as a keyboard, a mouse, or the like.

The display unit 14, which is used to display an operation screen used by the system administrator in response to a command from the control unit 11, is implemented using, for example, a liquid crystal display (LCD: Liquid Crystal Display), or the like.

The communication unit 15, which operates as a transceiver unit used for transmitting and receiving various types of information to and from the player terminals 20 over a network 2, is implemented using, for example, an NIC (Network Interface Card) or the like.

FIG. 3 is a diagram illustrating an example of a data structure of character information. This character information has configured therein, in conjunction with character IDs, at least a character name and a character image, as well as the initial and maximum values of various parameters, such as initial attack strength, maximum attack strength, initial defense strength, maximum defense strength, initial hit points, maximum hit points, and so forth.

FIG. 4 is a diagram illustrating an example of a data structure of player information. Such player information has configured therein, in conjunction with player IDs, at least a player name, a player ID, a friend player's player ID, the number of the balls owned by the player (hereinafter referred to as “proprietary balls”), a target game score, proprietary character information, i.e. information related to the characters owned by the player (hereinafter referred to as “proprietary characters”), and placement information, i.e. information related to the game content placement area.

FIG. 5 is a diagram illustrating an example of a data structure of proprietary character information. Such proprietary character information has configured therein, in conjunction with the character IDs of the proprietary characters, the current values of various parameters; at least, for example, level, attack strength, defense strength, and hit points.

FIG. 6 is a diagram illustrating an example of a data structure of placement information. Such placement information has game content configured therein in conjunction with the area IDs of the unit areas into which the game content placement area is divided. In the present embodiment, there is configured either one set of score-varying content, which adds 1 point to the player's score (+1), or special score-varying content, which doubles the player's score (×2). It should be noted that the points added to the player's score increase in a stepwise manner, i.e. the initial value is 1 point, and, as the game progresses, the value increases to 3 points, 5 points, and 10 points.

### <<Constitution of Player Terminal 20>>

FIG. 7 is a block diagram illustrating a functional constitution of the player terminal 20.

The player terminal 20 is an information processing device owned and used by the player (for example, a tablet terminal, a mobile phone terminal, a smartphone, etc.). Due to its web browser functionality, the player terminal 20 is capable of on-screen display of web pages (game screens, etc.) transmitted from the server device 10. The player terminal 20 has a terminal control unit 21, which provides overall control of the player terminal 20, a terminal storage unit 22, which stores various types of data and software programs (e.g., non-transitory computer readable medium having machine-executable instructions), a terminal control unit 23, which is used by the player for control input, a terminal display unit 24, which displays game screens and operation screens, and a terminal communication unit 25, which communicates information to and from the server device 10.

### <<Operation of Game System 1>>

FIG. 8 is a flow chart used to illustrate an example of operation of the game system 1. The target game, which varies the player's score by providing game content to the player by means of a lottery, will be discussed in specific detail below.

First of all, upon receiving the player's operation input, the player terminal 20 transmits a command to acquire the start page of the target game (game start page request) to the server device 10 (S101).

Next, after receiving the game start page request transmitted from the player terminal 20, the server device 10 places game content in each unit area of the game content placement area (S102). Namely, based on the placement information illustrated in FIG. 6, the game content placement unit 111 places score-varying content (“+1”) or special score-varying content (“×2”) in association with the respective unit areas.

Next, the server device 10 directs the screen data generation unit 116 to generate screen data (HTML files) used to display the start page (web page) of the target game on the player terminal 20 (S103). Namely, the screen data generation unit 116 generates a game screen that includes a game content placement area where game content is placed by the game content placement unit 111.

The server device 10 then transmits the thus generated screen data corresponding to the start page of the target game to the requesting player terminal 20 over a network (S104).

Subsequently, when this screen data transmitted from the server device 10 is received (S106), the player terminal 20 analyzes the screen data and directs the terminal display unit 24 to display the start page (game screen) of the target game (S106).

FIG. 9 is a diagram illustrating an example of a game screen 50 used in the target game. This game screen 50 includes a game content placement area 51 and a control button 52 used for throwing balls. Here, eight score-varying content items (“+1”) and one special score-varying content item 51A (“×2”), as an example of special game content, are placed in the game content placement area 51.

Next, going back to FIG. 8, when the game screen 50 of the target game is displayed on the terminal display unit 24, the player terminal 20 transmits a command to provide game content (game content provision request) to the server device 10 based on this operation information when the control button 52 is selected by the player (S107).

Next, when the game content provision request transmitted from the player terminal 20 is received, the server device 10 executes a process whereby game content determined by means of a lottery is provided to the player (S108).

Specifically, the game content provision unit 112 spends one of the player's proprietary balls (see FIG. 4) to provide the player with one game content item selected from the nine game content items placed in the game content placement area 51 in accordance with a preset drawing probability. In the present embodiment, the drawing probability of game content is set as follows. The drawing probability obtained when the game content provision unit 112 selects game content is varied by weighting each of the respective score-varying content items and special score-varying content items. For example, as shown in FIG. 9, when special score-varying content 51A (“×2”) is placed only in one square out of the nine squares and score-varying content (“+1”) is placed in the remaining eight squares, the weight of the special score-varying content is set to 1, the weight of the score-varying content is set to 10, the probability of selecting the special score-varying content item is configured to be 1/81, and the probability of selecting the respective score-varying content items is configured to be 10/81. By doing so, the special score-varying content and the score-varying content are prevented from being selected with the same drawing probability of 1/9.

Next, the server device 10 calculates the modified score based on the game content provided by the game content provision unit 112 (S109). Namely, when a score-varying content item (“+1”) is selected by the game content provision unit 112, the score updating unit 113 adds 1 point to the player's score (see FIG. 4). In addition, when a special score-varying content item (“×2”) is selected by the game content provision unit 112, the player's score is doubled. After that, the score updating unit 113 updates the score indicated in the player information shown in FIG. 4.

It should be noted that, as will be discussed in more detail below, if the point increment of the score-varying content items is increased in a stepwise manner (in a 4-tiered manner, starting from 1 point, i.e. the initial value, and increasing to 3 points, 5 points, and 10 points) whenever special score-varying content (“×2”) is provided, the score updating unit 113 increases the points added to the player's score from the initial value (1 point). In addition, in such a case, the score updating unit 113 may reset the points added to the player's score back to the initial value (1 point) upon lapse of a predetermined limited time after moving up to the next level.

Next, when the game content provision request transmitted from the player terminal 20 is received, the server device 10 counts the number of times the operation of throwing the ball has been performed by the player (S110). Namely, the counting unit 114 counts the number of times the control button 52 (see FIG. 9) has been selected by the player and updates the number of operations indicated in the player information shown in FIG. 4. It should be noted that when a special score-varying content item (“×2”) is selected by the game content provision unit 112, the number of operations (accrued number of operation) counted up to the present moment is reset to 0.

Next, when a score-varying content item (“+1”) or a special score-varying content item (“×2”) is provided to the player by the game content provision unit 112, the server device 10 places the new game content item in the game content placement area 51 (S111). Cases involving provision of score-varying content items (“+1”) and cases involving provision of special score-varying content items (“×2”) will be respectively discussed below.

FIG. 10 is a diagram illustrating state transitions in the game content placement area. When a score-varying content item (“+1”) is provided by the game content provision unit 112, an empty state is generated in the game content placement area. For this reason, the game content placement unit 111 places new game content in squares that are in that empty state.

Specifically, based on a predetermined probability of occurrence, the game content placement unit 111 selects and places either a score-varying content item (“+1”) or a special score-varying content item (“×2”). At this time, the placement information shown in FIG. 6 is updated. In addition, in the present embodiment, the probability of occurrence of game content is set as follows. The probability of score-varying content items being placed (probability of occurrence) in the game content placement area is set to be higher than that of special score-varying content items. Furthermore, the probability of occurrence is set such that more special score-varying content items are placed in the game content placement area as the number of operations that have been performed by the player (number of ball throws) increases. For example, when the number of the player's operations is within the range of 1-20, based on the player information shown in FIG. 4, the probability of occurrence of score-varying content items (“+1”) is set to 9/10 by the game content placement unit 111 and the probability of occurrence of special score-varying content items (“×2”) is set to 1/10. In addition, when the number of the player's operations is within the range of 21-40, the probability of occurrence of score-varying content items (“+1”) is set to 7/10 and the probability of occurrence of special score-varying content items (“×2”) is set to 3/10.

As a result, as long as no special score-varying content items (“×2”) are selected in the game content placement area, repeatedly playing the target game causes the state inside the area to gradually transition as depicted in FIG. 10A→FIG. 10B→FIG. 10C. Accordingly, the more proprietary balls the player throws, the more special score-varying content items (“×2”) are placed in the game content placement area, thereby making it possible to increase the probability that a special score-varying content item will be provided to the player.

FIG. 11 is a diagram illustrating state transitions in the game content placement area. If a special score-varying content item (“×2”) is provided by the game content provision unit 112, the game content placement area is modified and goes to the next level.

Specifically, whenever a special score-varying content item (“×2”) is provided by the game content provision unit 112, the game content placement unit 111 places score-varying content items in the game content placement area, with the point increment of the items increasing in a stepwise manner. At this time, the placement information shown in FIG. 6 is updated. In addition, in the present embodiment, as shown in FIG. 11A-FIG. 11D, score-varying content items that are increased in a 4-tiered manner, starting from 1 point, i.e. the initial value, and increasing to 3 points, 5 points, and 10 points, are placed in the game content placement area.

Accordingly, as a result of repeatedly playing the target game, whenever a special score-varying content item (“×2”) is selected in the game content placement area, the state of the area gradually transitions as depicted in FIG. 11A→FIG. 11B→FIG. 11C→FIG. 11D. Accordingly, as the number of thrown proprietary balls increases, the point increment of the score-varying content items is successively increased, thereby readily increasing the player's score even if no special score-varying content items (“×2”) are provided. Furthermore, it becomes possible to substantially increase the player's score if a special score-varying content item (“×2”) is provided after increasing the score in this manner.

It should be noted that if score-varying content items with point increments increasing in a stepwise manner are placed in the game content placement area, then score-varying content items reset to 1 point, i.e. the initial value, may be placed in the game content placement area by the game content placement unit 111 upon lapse of a predetermined limited time after moving up to the next level. Accordingly, the player's score can be minimized to prevent it from increasing in an excessive manner.

Next, going back to FIG. 8, when the player's score is computed and the content placed in the next game content placement area is determined in this manner, the server device 10 directs the screen data generation unit 116 to generate screen data (HTML files) used to display the start page (web page) of the next target game on the player terminal 20 (S112). In other words, the screen data generation unit 116 generates a game screen that includes a new game content placement area.

The server device 10 then transmits the thus generated screen data, corresponding to the start page of the next target game, to the requesting player terminal 20 over a network (S113).

Subsequently, when this screen data transmitted from the server device 10 is received (S114), the player terminal 20 analyzes the screen data and directs the terminal display unit 24 to display the start page (game screen) of the next target game (S115). The player can play target games in a continuous manner, thereby increasing the score.

In this manner, the player can obtain a reward corresponding to his or her score if the player continues increasing his or her score by repeatedly playing target games. When a reward allocation request is received from the player terminal 20, the reward allocation unit 117 refers to the player information shown in FIG. 4 and provides a character corresponding to the score gained by the player in the target game (see FIG. 3) as a reward.

As described above, in the game system 1 according to the present embodiment, when the player plays a game using proprietary balls, special score-varying content items (“×2”) or score-varying content items (“+1”) selected in the game content placement area 51 are provided and reflected in the player's score. Also, as a result, the player's score can be increased not only when the special score-varying content (“×2”) is provided, but also when non-special score-varying content (“+1”) is provided, which makes it possible to increase the player's motivation to play before and after acquiring the special game content (“×2”). In addition, since in the game system 1 according to the present embodiment the probability of providing special score-varying content (“×2”) can be increased as the number of balls thrown by the player increases, it becomes easy to increase the player's score and makes it possible to raise the player's motivation to play.

### Other Embodiments

The foregoing embodiment was intended to aid in the understanding of the present invention and is not to be construed as limiting the present invention. The present invention can be modified and improved without departing from its essential meaning. At the same time, the present invention includes equivalents thereto. In particular, the embodiments described below are also included in the present invention.

### <Game Content>

Although the present embodiment as described above has been discussed by representing the placement of special score-varying content and score-varying content in the game content placement area using numerals, such as “×2” and “+1”, the present invention is not limited thereto. For example, placement in the game content placement area may be represented using symbols such as ordinary markings and special markings, as well as ordinary characters and special characters. In addition, one point may be added to the player's score when ordinary markings and ordinary characters are provided to the player, and the player's score may be doubled when special markings and special characters are provided.

In addition, although the present embodiment as described above has been discussed with reference to a case in which the game content placed in the game content placement area is limited to special score-varying content and score-varying content, the present invention is not limited thereto. For example, only special score-varying content items or only score-varying content items may be used. Alternatively, characters may be included as game content.

In addition, although the present embodiment as described above has been discussed with reference to a case in which one point is added to the player's score as an initial value if a score-varying content item is provided, the present invention is not limited thereto. For example, 2 points, 3 points, 4 points, and so on may be added to the player's score as an initial value.

In addition, although the present embodiment as described above has been discussed with reference to a case in which the player's score is doubled if a special score-varying content item is provided, the present invention is not limited thereto. For example, the player's score may be tripled, quadrupled, quintupled, and so on. In addition, 100 points, 500 points, 1000 points, and so on may be added to the player's score.

### <Probability of Providing Special Score-Varying Content>

Although the above-mentioned embodiment has been discussed with reference to a case in which the probability of providing special score-varying content is increased due to the fact that more special score-varying content items are placed in the game content placement area (due to fact that the probability of occurrence of special score-varying content is increased) as the number of the player's operations (number of ball throws) increases, the present invention is not limited thereto. For example, the probability of providing special score-varying content may be increased by increasing the probability of selecting special score-varying content from the game content placement area (selection probability) as the number of the player's operations (number of ball throws) increases.

In addition, although the present embodiment as described above has been discussed with reference to a case in which the probability of providing special score-varying content is increased as the number of the player's operations (number of ball throws) increases, the present invention is not limited thereto. For example, the probability of providing special score-varying content may be increased by placing more special score-varying content items in the game content placement area (by increasing the probability of occurrence of special score-varying content) as the player's score increases.

### <Reset>

Although the present embodiment as described above has been discussed with reference to a case in which the number of the player's operations (accrued number of operations) is reset if a special score-varying content item is provided, the present invention is not limited thereto. For example, a limited time, during which game content can be provided, may be set up in the target game and the number may be reset upon lapse of this limited time.

### <Ball Acquisition>

The above-mentioned embodiment is configured such that a player (hereinafter referred to as “supporting player”) can support a friend player (hereinafter referred to as “supported player”) challenged to the target game with a view to acquire special score-varying content, as a result of which balls are provided respectively to the supported player and to the supporting player. Specifically, on the game screen 60 used for game viewing, which is shown in FIG. 12, the supporting player can see the supported player's game content placement area 61 (a plurality of special score-varying content items 61A have been placed here) and selects the control button 62. As the control unit 11 responds to this operation, balls are provided to the supported player and to the supporting player, and the number of proprietary balls of both players (see FIG. 4) is updated. This makes it possible to activate communication between the players.

### <Game Content Placement Area>

Although the present embodiment as described above has been discussed with reference to a game content placement area composed of 3×3, i.e. 9 squares, the present invention is not limited thereto. In addition, the unit areas that constitute the game content placement area are not limited to squares of square shape.

### <Server Device>

Although the present embodiment as described above has been discussed with respect to a game system 1 equipped with a single server device 10 as an example of a server device, the invention is not limited thereto, and a game system 1 equipped with a plurality of server devices 10, as an example of server devices, may also be used. In other words, a plurality of server devices 10 may be connected over a network 2 and these server devices 10 may perform various types of processing in a distributed manner.

### <Information Processing Device>

Although the game system 1 used in the present embodiment as described above has been discussed with respect to a case in which various types of information processing are carried out by directing the server device 10 and the player terminals 20 to cooperate in performing various types of information processing in accordance with a game program (e.g., non-transitory computer readable medium having machine-executable instructions), the invention is not limited thereto, and the above-mentioned various types of information processing may be carried out based on a game program using only the server device 10 or only the player terminals 20 as information processing devices.

In addition, a constitution may be used in which the player terminals 20 support some of the information processing device functionality. In such a case, the server device 10 and player terminals 20 form an information processing device.

It should be noted that the information processing device is, for example, a computer equipped with a processor and a memory.

### DESCRIPTION OF THE REFERENCE NUMERALS

1 Game system
2 Network
10 Server device
11 Control unit
12 Storage unit
13 Input unit
14 Display unit
15 Communication unit
20 Player terminal
21 Terminal control unit
22 Terminal storage unit
23 Terminal input unit
24 Terminal display unit
25 Terminal communication unit
50 Game screen
51 Game content placement area
51A Special score-varying content
52 Control button
60 Game screen
61 Game content placement area
61A Special score-varying content
62 Control button
111 Game content placement unit
112 Game content provision unit
113 Score updating unit
114 Counting unit
115 Battle processing unit
116 Screen data generation unit
117 Reward allocation unit

1. An information processing device equipped with a screen data generation unit that generates screen data that is used to display, on a game screen, a game content placement area where a plurality of game content items are placed; a game content placement unit that places, in the game content placement area, at least one set of score-varying content that varies a player's score and special score-varying content that varies the score more strongly than the score-varying content; a game content provision unit that provides the player with game content selected in the game content placement area in response to the player's operations; a score updating unit that updates the player's score by varying the score in accordance with the respective content when the game content provided to the player is the score-varying content or the special score-varying content; a counting unit that counts the number of the player's operations whenever the player performs an operation in order for game content to be provided by the game content provision unit, wherein the game content placement unit places more special score-varying content in the game content placement area as the number of the player's operations counted up to the provision of the special score-varying content by the game content provision unit increases, and, whenever the special score-varying content is provided by the game content provision unit, the next-level score-varying content, which is capable of varying the player's score more strongly than the previous-level score-varying content already placed in the game content placement area, is placed in the game content placement area.

2. An information processing device equipped with a screen data generation unit that generates screen data that is used to display, on a game screen, a game content placement area where a plurality of game content items are placed; a game content placement unit that places, in the game content placement area, at least one set of score-varying content that varies a player's score and special score-varying content that varies the score more strongly than the score-varying content; a game content provision unit that provides the player with game content selected in the game content placement area in response to the player's operations; a score updating unit that updates the player's score by varying the score in accordance with the respective content when the game content provided to the player is the score-varying content or the special score-varying content; and a counting unit that counts the number of the player's operations whenever the player performs an operation in order for game content to be provided by the game content provision unit, wherein the game content placement unit configures the probability that the special score-varying content will be placed in the game content placement area such that the probability becomes higher in accordance with the number of the player's operations that has been counted up to the provision of the special score-varying content by the game content provision unit, and, whenever the special score-varying content is provided by the game content provision unit, the next-level score-varying content, which is capable of varying the player's score more strongly than the previous-level score-varying content already placed in the game content placement area, is placed in the game content placement area.

3. The information processing device according to claim 1, wherein the counting unit resets the number of the player's operations upon lapse of a limited time during which game content can be provided, or upon provision of special score-varying content by the game content provision unit.

4. The information processing device according to claim 1, wherein the score updating unit is adapted such that when the game content provided to the player is the score-varying content, updating is performed by adding predetermined points to the player's score; when the game content provided to the player is the special score-varying content, updating is performed by multiplying the player's score by a predetermined number larger than 1; and, furthermore, such that whenever the special score-varying content is provided by the game content provision unit, the predetermined points added to the player's score are increased relative to an initial value.

5. The information processing device according to claim 4, wherein the score updating unit is adapted to reset the predetermined points added to the player's score back to the initial value upon lapse of a limited time.

6. A game program that directs a computer to execute a screen data generation process for generating screen data that is used to display, on a game screen, a game content placement area where a plurality of game content items are placed; a game content placement process for placing, in the game content placement area, at least one set of score-varying content that varies a player's score and special score-varying content that varies the score more strongly than the score-varying content; a game content provision process for providing the player with game content selected in the game content placement area in response to the player's operations; a score updating process for updating the player's score by varying the score in accordance with the respective content when the game content provided to the player is the score-varying content or the special score-varying content; a counting process for counting the number of the player's operations whenever the player performs an operation in order for game content to be provided by the game content provision process, wherein the game content placement process places more special score-varying content in the game content placement area as the number of the player's operations counted up to the provision of the special score-varying content by the game content provision process increases, and, whenever the special score-varying content is provided by the game content provision process, the next-level score-varying content, which is capable of varying the player's score more strongly than the previous-level score-varying content already placed in the game content placement area, is placed in the game content placement area.

7. A non-transitory computer readable medium having machine-executable instructions that direct a computer to execute a screen data generation process for generating screen data that is used to display, on a game screen, a game content placement area where a plurality of game content items are placed; a game content placement process for placing, in the game content placement area, at least one set of score-varying content that varies a player's score and special score-varying content that varies the score more strongly than the score-varying content; a game content provision process for providing the player with game content selected in the game content placement area in response to the player's operations; a score updating process for updating the player's score by varying the score in accordance with the respective content when the game content provided to the player is the score-varying content or the special score-varying content; and a counting process for counting the number of the player's operations whenever the player performs an operation in order for game content to be provided by the game content provision process, wherein the game content placement process configures the probability that the special score-varying content will be placed in the game content placement area such that it becomes higher in accordance with the number of the player's operations that has been counted up to the provision of the special score-varying content by the game content provision process, and, whenever the special score-varying content is provided by the game content provision process, the next-level score-varying content, which is capable of varying the player's score more strongly than the previous-level score-varying content already placed in the game content placement area, is placed in the game content placement area.
